(19) United States
(12) Patent Application Publication
(10) Pub. No.: US 2024/0367630 A1
(43) Pub. Date: Nov. 7, 2024

(54) BRAKING CONTROL DEVICE FOR VEHICLE

(71) Applicant: ADVICS CO., LTD., Kariya-shi, Aichi-ken (JP)

(72) Inventor: Takenao HATTORI, Kariya-shi, Aichi-ken (JP)

(73) Assignee: ADVICS CO., LTD., Kariya-shi, Aichi-ken (JP)

(21) Appl. No.: 18/686,762

(22) PCT Filed: Jul. 29, 2022
(86) PCT No.: PCT/JP2022/029374

§ 371 Date: Feb. 26, 2024

(30) Foreign Application Priority Data
Sep. 2, 2021 (JP) 2021-143310

(51) Int. Cl. B60T 13/66; B60T 8/172

(52) U.S. Cl. CPC B60T 13/662; B60T 8/172

(57) ABSTRACT

A braking control device includes an information acquisition unit that acquires vehicle outside-condition information regarding a situation outside a vehicle, and a setting unit that sets responsivity of a braking operation according to an indicator output from a learning apparatus by inputting the vehicle outside-condition information acquired by the information acquisition unit to the learning apparatus.

### TECHNICAL FIELD

The present disclosure relates to a braking control device for a vehicle.

### BACKGROUND ART

Patent Literature 1 discloses learning a braking distance when a preceding vehicle is not present during manual driving in manual driving and automatic driving by a driver of a vehicle, and reflecting a learning result in a travel characteristic of the automatic driving.

### CITATIONS LIST

### Patent Literature

Patent Literature 1: WO 2018/163288 A

### SUMMARY

### Technical Problems

However, there is room for improvement in the control of the braking device for the vehicle according to the vehicle outside-condition since the vehicle outside-condition, which is the external situation of the vehicle, is diverse. An object of the present disclosure is to provide a vehicle braking control device capable of setting suitable responsivity of a braking operation according to a wide variety of vehicle outside-conditions.

### Solutions to Problems

A braking control device for a vehicle to solve the above problem is a device applied to a braking device that applies a braking force to a wheel of the vehicle. The braking control device includes: an information acquisition unit that acquires vehicle outside-condition information that is information regarding a situation outside the vehicle; and a setting unit that sets responsivity of a braking operation according to an indicator output from a learning apparatus by inputting the vehicle outside-condition information acquired by the information acquisition unit to the learning apparatus that has performed machine learning for estimating a probability of occurrence of the braking operation for applying a braking force to the wheel based on a situation outside the vehicle in the braking device.

As described above, there are a wide variety of vehicle outside-conditions. Therefore, it is not easy to obtain the probability by conditional branching using a large number of parameters defining a wide variety of vehicle outside-conditions as inputs. In this regard, according to the above configuration, the probability corresponding to the vehicle outside-condition information can be obtained by inputting the vehicle outside-condition information acquired by the host vehicle to the learning apparatus. Therefore, the responsivity of the braking operation can be suitably set according to a wide variety of vehicle outside-conditions.

### BRIEF DESCRIPTION OF DRAWINGS

FIG. 1 is a schematic diagram of a vehicle according to a first embodiment.

FIG. 2 is a partial cross-sectional view illustrating a schematic configuration of a friction brake mounted on the vehicle.

FIG. 3 is a flowchart for explaining a flow of control related to pre-braking processing executed by a braking control device mounted on the vehicle.

FIG. 4 is a schematic diagram illustrating a method of machine learning according to the first embodiment.

FIG. 5 is a flowchart illustrating a flow of control related to learning processing executed by a learning device according to the first embodiment.

FIG. 6 is a schematic diagram illustrating a vehicle and an external vehicle server device according to a second embodiment.

FIG. 7 is a sequence diagram illustrating a flow of pre-braking processing executed in the vehicle and the external vehicle server device of the second embodiment.

### DESCRIPTION OF EMBODIMENTS

### (First Embodiment

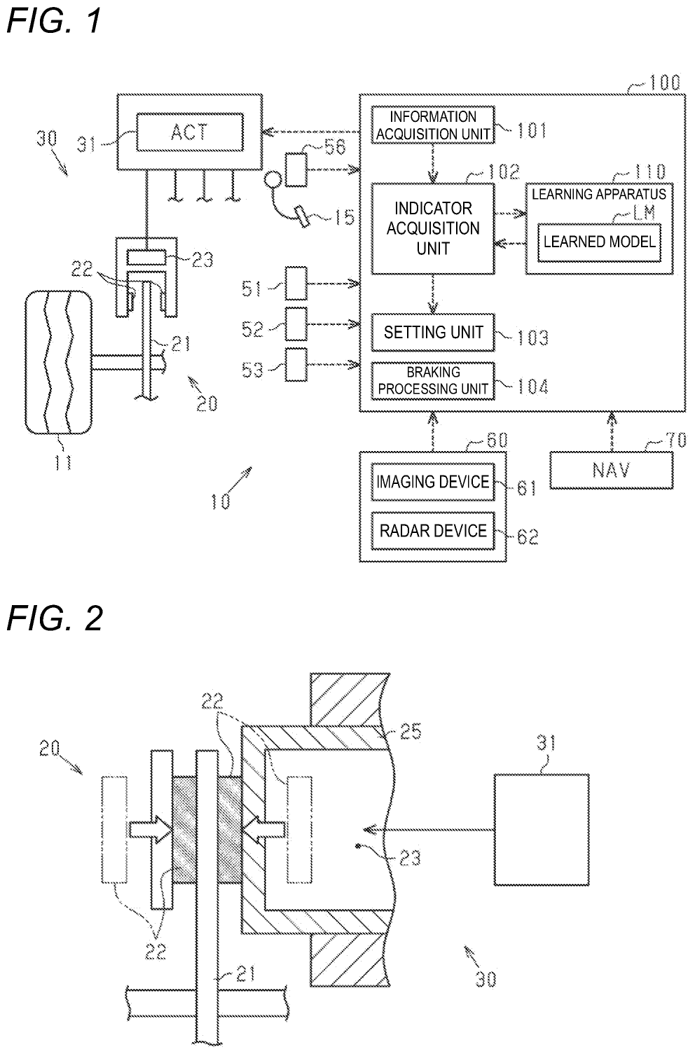

Hereinafter, a first embodiment will be described with reference to FIGS. 1 to 5.

FIG. 1 is a diagram illustrating a vehicle 10 according to the present embodiment, a braking device 30 mounted on the vehicle 10, and a braking control device 100 that controls the braking device 30.

### Braking Device

The braking device 30 includes a friction brake 20. The friction brake 20 is a braking mechanism that applies a braking force to the corresponding wheel 11.

The friction brake 20 is, for example, a caliper type braking mechanism. The friction brake 20 includes a rotor 21 as a portion to be rubbed that rotates integrally with the wheel 11, and a brake pad 22 as a friction portion.

FIG. 2 is a partial cross-sectional view illustrating the friction brake 20. The friction brake 20 is configured such that the brake pad 22 can be displaced in the approaching direction and the separating direction with respect to the rotor 21. The approaching direction is a direction in which the brake pad 22 relatively approaches the rotor 21. The separating direction is a direction in which the brake pad 22 is relatively separated from the rotor 21.

In a state where the friction brake 20 does not apply the braking force to the wheel 11 as indicated by a two-dot chain line in FIG. 2, the brake pad 22 is separated from the rotor 21. On the other hand, as indicated by a solid line in FIG. 2, in a state where the friction brake 20 applies a braking force to the wheel 11, the brake pad 22 comes into contact with the rotor 21.

The friction brake 20 includes a wheel cylinder 23. For example, when the driver of the vehicle 10 operates a brake pedal 15, the brake fluid is supplied into the wheel cylinder 23, so that the WC pressure, which is the fluid pressure in the wheel cylinder 23, increases. As a result, a piston 25 of the wheel cylinder 23 moves, and the brake pad 22 approaches the rotor 21 as indicated by a white arrow in FIG. 2. When the brake pad 22 comes into contact with the rotor 21, a braking force is applied to the wheel 11.

As illustrated in FIG. 1, the braking device 30 includes an actuator (ACT) 31. The braking device 30 is configured to be able to adjust the WC pressure by actuation of the actuator 31. Therefore, even when the brake pedal 15 is not operated, the braking device 30 can apply the braking force to the wheel 11 by the operation of the actuator 31.

### Sensor System

The sensor system of the vehicle 10 includes, for example, a wheel speed sensor 51, a longitudinal acceleration sensor 52, a yaw rate sensor 53, a brake switch 56, and the like. The wheel speed sensor 51 detects a wheel speed WS which is a rotation speed of the wheel 11, and outputs a detection signal corresponding to the wheel speed WS to the braking control device 100. The longitudinal acceleration sensor 52 detects the longitudinal acceleration Gx of the vehicle 10 and outputs a detection signal corresponding to the longitudinal acceleration Gx to the braking control device 100. The yaw rate sensor 53 detects a yaw rate Yr of the vehicle 10 and outputs a detection signal corresponding to the yaw rate Yr to the braking control device 100. The brake switch 56 outputs a signal related to the presence or absence of the operation of the brake pedal 15 to the braking control device 100.

### Vehicle Exterior Monitoring System

The vehicle 10 includes a vehicle exterior monitoring system 60 that monitors the condition outside the vehicle 10. The vehicle exterior monitoring system 60 includes, for example, an imaging device 61 and a radar device 62. The imaging device 61 images the outside of the vehicle 10. The radar device 62 detects, for example, distances between the vehicle 10 and other vehicles, pedestrians, and obstacles located around the vehicle 10. The vehicle exterior monitoring system 60 outputs image information, which is information such as an image captured by the imaging device 61, and radar information, which is information detected by the radar device 62, to the braking control device 100.

The braking control device 100 acquires map information from a navigation device (NAV) 70. The map information is information on the current position of the vehicle 10. The navigation device 70 may be an in-vehicle navigation device provided in the vehicle 10 or may be a portable terminal owned by the driver of the vehicle 10.

### Braking Control Device

The braking control device 100 includes a CPU that is a calculation unit and a storage unit. The storage unit includes a ROM. The ROM stores various control programs executed by the CPU and a learned model LM constituting a learning apparatus 110. That is, the braking control device 100 includes the learning apparatus 110.

When the CPU executes the control program stored in the storage unit, the braking control device 100 functions as an information acquisition unit 101, an indicator acquisition unit 102, a setting unit 103, and a braking processing unit 104.

The information acquisition unit 101 acquires vehicle outside-condition information that is information regarding the outside of the vehicle 10. For example, the information acquisition unit 101 acquires imaging information, radar information, and map information as vehicle outside-condition information. The information acquisition unit 101 may acquire information that can be grasped from the imaging information, the radar information, and the map information as the vehicle outside-condition information.

The indicator acquisition unit 102 acquires an indicator IND indicating the probability of the braking operation based on the vehicle outside-condition information acquired by the information acquisition unit 101. Specifically, the indicator acquisition unit 102 inputs the vehicle outside-condition information to the learning apparatus 110, and acquires a value output from the learning apparatus 110 as the indicator IND.

Here, the probability of the braking operation is the probability that the braking operation occurs in the braking device 30. The probability of the braking operation can also be said to be a possibility that a braking request, which is a request for applying a braking force to the wheel 11, is made to the braking device 30. In the present embodiment, even when the braking force is applied to the wheel 11 due to the operation of the brake pedal 15 by the driver, and also when the braking force is applied to the wheel 11 by the operation of the actuator 31 under a condition where the brake pedal 15 is not operated, it is regarded that the braking operation has occurred in the braking device 30.

The probability of the braking operation correlates with the vehicle outside-condition. For example, it is recognized that the probability of the braking operation tends to increase as the number of other vehicles and pedestrians existing around the vehicle 10 increases, the distance to these vehicles and pedestrians decreases, and the width of the road on which the vehicle 10 is traveling decreases. It is recognized that the probability of the braking operation tends to increase as the number of traffic lights, intersections, and curve sections on the road on which the vehicle 10 is traveling increases, and the distance to the traffic lights, intersections, and curve sections decreases. When the vehicle 10 is traveling on a general road, the probability of the braking operation tends to be higher than that when the vehicle 10 is traveling on an expressway. When the vehicle 10 is traveling in an urban area, the probability of the braking operation tends to be higher than when the vehicle 10 is traveling in a suburb. When the vehicle 10 is traveling in a downhill slope, the probability of the braking operation tends to be higher than when the vehicle 10 is traveling in an uphill slope.

The learning apparatus 110 is constructed by a learned model LM that has performed machine learning for estimating the probability of the braking operation based on the vehicle outside-condition. For example, the learned model LM is a forward propagation neural network. When the vehicle outside-condition information is input, the learned model LM outputs a value indicating the probability of the braking operation according to the vehicle outside-condition information as the indicator IND. For example, the indicator IND has a larger value as the probability of the braking operation is higher. That is, the learned model LM maps the vehicle outside-condition to the probability of the braking operation. A method of generating the learned model LM will be described later.

The setting unit 103 sets responsivity of the braking operation according to the indicator IND acquired by the indicator acquisition unit 102. For example, when the degree of probability of the braking operation indicated by the indicator IND is equal to or greater than a predetermined threshold, the setting unit 103 executes processing for causing the friction brake 20 to prepare for the braking operation. The above preparation is referred to as “braking preparation”, and the above process is referred to as “braking preparation processing”. On the other hand, the setting unit 103 does not execute the braking preparation processing when the degree of probability of the braking operation indicated by the indicator IND is less than the predetermined threshold.

An example of the braking preparation processing will be described with reference to FIG. 2. The setting unit 103 executes the pre-braking processing as the braking preparation processing. The pre-braking processing is a process of causing the brake pad 22 of the friction brake 20 to relatively approach the rotor 21 by the operation of the actuator 31. By executing such a pre-braking processing, an idle running time, which is the time from the time when the braking request is generated with respect to the braking device 30 until the braking force corresponding to the braking request is actually applied to the wheel 11, can be shortened.

In the pre-braking processing, the brake pad 22 may not be brought into contact with the rotor 21, or the brake pad 22 may be brought into contact with the rotor 21. However, when the brake pad 22 is brought into contact with the rotor 21, the braking force applied to the wheel 11 is assumed to be very small.

The braking processing unit 104 controls the actuator 31 of the braking device 30 when generating the braking force in the vehicle 10. That is, the braking processing unit 104 operates the actuator 31 to adjust the braking force applied to the wheel 11.

### Control Related to Pre-Braking Processing

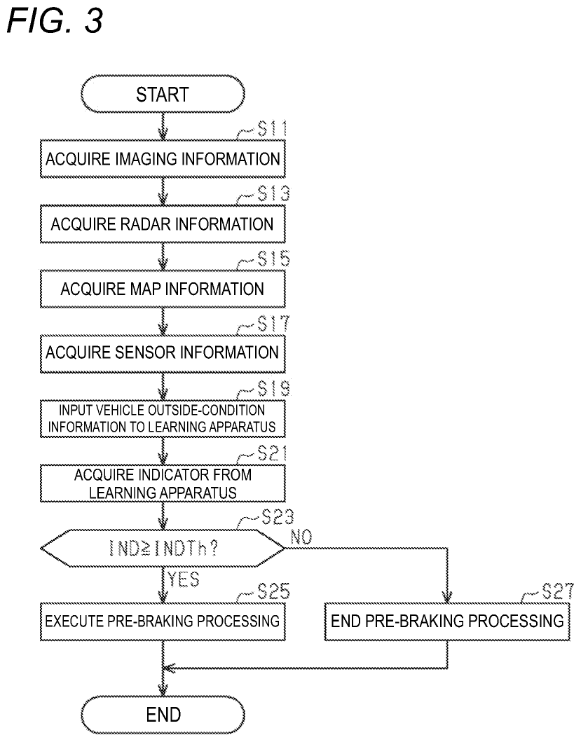

FIG. 3 is a flowchart illustrating a flow of control related to the pre-braking processing. This control is executed by the braking control device 100.

In the control illustrated in FIG. 3, in step S11, the braking control device 100 functions as the information acquisition unit 101 to acquire the image information output by the vehicle exterior monitoring system 60.

In step S13, the braking control device 100 functions as the information acquisition unit 101 to acquire radar information output by the vehicle exterior monitoring system 60.

By analyzing the imaging information, the braking control device 100 can grasp, as the condition around the vehicle 10, for example, the number of other vehicles and pedestrians traveling around the vehicle 10, the distance between the vehicle 10 and other vehicles and pedestrians, whether a traffic light exists around the vehicle 10, the width of the road on which the vehicle 10 travels, and the like. The braking control device 100 can grasp, for example, the number of other vehicles and pedestrians traveling around the vehicle 10 and the distance between the vehicle 10 and other vehicles and pedestrians by analyzing the radar information.

The braking control device 100 (information acquisition unit 101) may acquire the imaging information and the radar information as the vehicle outside-condition information, or may acquire information that can be grasped from the imaging information and the radar information as the vehicle outside-condition information.

In step S15, the braking control device 100 functions as the information acquisition unit 101 to acquire the map information output by the navigation device 70.

As the map information, for example, information regarding an area where the vehicle 10 is traveling and information regarding a road where the vehicle 10 is traveling are conceivable. For example, as the information regarding the area where the vehicle 10 is traveling, information indicating whether the vehicle 10 is traveling in an urban area or the vehicle 10 is traveling in a suburb can be considered. Examples of the information on the road on which the vehicle 10 is traveling include information indicating whether the vehicle 10 is traveling on a traffic light, an intersection, or a road with relatively many curves or whether the vehicle 10 is traveling on a traffic light, an intersection, or a road with relatively few curves, information indicating whether the vehicle 10 is traveling on a general road or the vehicle 10 is traveling on an expressway, and information indicating whether the vehicle 10 is traveling on a downhill slope or the vehicle 10 is traveling on a uphill slope. The braking control device 100 (information acquisition unit 101) acquires at least one of map information and information that can be grasped from the map information as vehicle outside-condition information.

In step S17, the braking control device 100 functions as the information acquisition unit 101 to acquire at least one of detection values of the various sensors 51 to 53 provided in the vehicle 10, for example, the wheel speed WS, the longitudinal acceleration Gx, and the yaw rate Yr, as sensor information. In addition, the braking control device 100 can acquire the behavior of the vehicle 10 that can be grasped from these detection values as sensor information. As the behavior of the vehicle 10 described herein, a traveling speed, acceleration, a turning state, and the like of the vehicle 10 are considered.

In step S19, the braking control device 100 functions as the indicator acquisition unit 102 to input the acquired vehicle outside-condition information and sensor information to the learning apparatus 110. In step S21, the braking control device 100 functions as the indicator acquisition unit 102 to acquire the value output from the learning apparatus 110 as the indicator IND.

In step S23, the braking control device 100 functions as the setting unit 103 to determine whether the indicator IND is greater than or equal to an indicator determination value INDTh. The indicator determination value INDTh is a threshold for evaluating the degree of probability of the braking operation indicated by the indicator IND.

When the indicator IND is greater than or equal to the indicator determination value INDTh (S23: YES), the braking control device 100 proceeds to the processing of step S25. On the other hand, when the indicator IND is less than the indicator determination value INDTh (S23: NO), the braking control device 100 proceeds to the processing of step S27.

In step S25, the braking control device 100 functions as the setting unit 103 to execute the pre-braking processing described above. As a result, in the friction brake 20, the brake pad 22 approaches the rotor 21. Therefore, responsivity of the braking operation in the braking device 30 is enhanced. Thereafter, the braking control device 100 temporarily ends the control illustrated in FIG. 3.

In step S27, the braking control device 100 functions as the setting unit 103 to end the execution of the pre-braking processing. For example, the setting unit 103 stops driving of the actuator 31 of the braking device 30. As a result, in the friction brake 20, the brake pad 22 is separated from the rotor 21. Thereafter, the braking control device 100 temporarily ends the control illustrated in FIG. 3.

### Method of Generating Learned Model LM

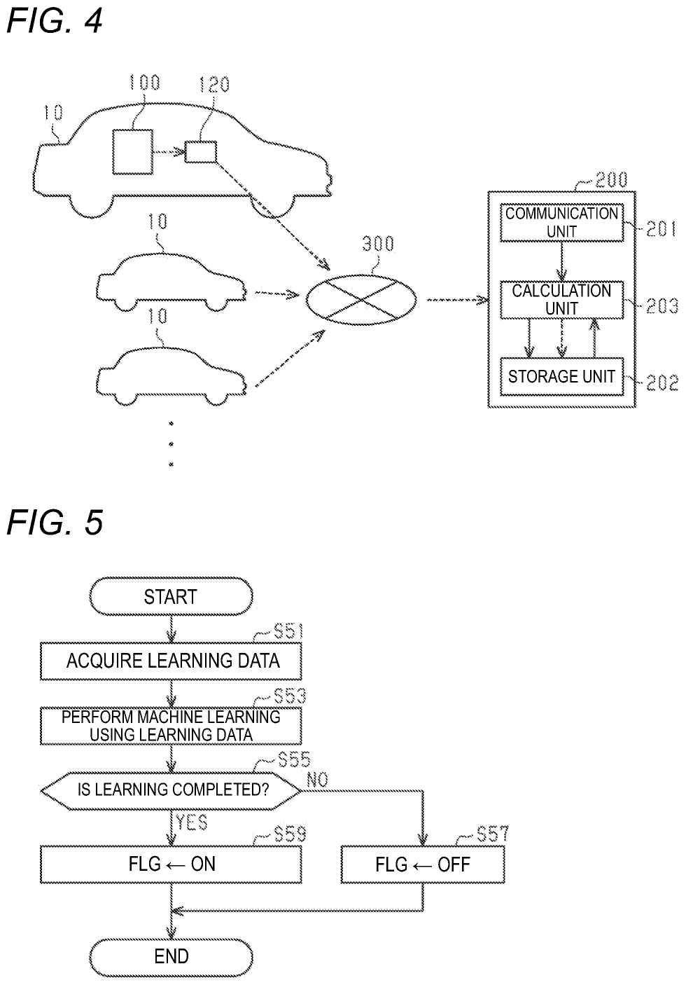

A method of generating the learned model LM constructing the learning apparatus 110 will be described with reference to FIGS. 4 and 5.

As illustrated in FIG. 4, a learning device 200 is installed outside the vehicle 10. The learning device 200 performs machine learning for estimating the probability of the braking operation based on learning data LD acquired from the vehicle 10. A result of such machine learning is the learned model LM.

The learning device 200 includes a communication unit 201, a storage unit 202, and a calculation unit 203. A learning program LP is stored in the storage unit 202 of the learning device 200. On the other hand, the vehicle 10 includes a braking control device 100 and a communication unit 120.

The calculation unit 203 of the learning device 200 executes the learning program LP. As a result, the calculation unit 203 acquires the learning data LD from the braking control devices 100 of the plurality of vehicles 10 via the communication unit 120, the network 300, and the communication unit 201. The calculation unit 203 stores the acquired learning data LD in the storage unit 202. Then, the calculation unit 203 performs the machine learning using the learning data LD stored in the storage unit 202, and stores a learning result LR that is a result of the machine learning in the storage unit 202.

In the present embodiment, the learning data LD includes the following information.
Braking-time vehicle outside-condition information that is vehicle outside-condition information at the time when the braking operation occurs in the vehicle 10 or immediately before or after the time.
Braking-time sensor information that is sensor information at the time when a braking operation occurs in the vehicle 10 or immediately before or after the time.
Non-braking-time vehicle outside-condition information that is the vehicle outside-condition information in a state where the braking operation is not generated in the vehicle 10.
Non-braking sensor information that is sensor information in a state where the braking operation is not generated in the vehicle 10.

In the following description, the braking-time vehicle outside-condition information and the braking-time sensor information are referred to as “braking-time vehicle outside-condition information and the like”. Further, the non-braking-time vehicle outside-condition information and the non-braking sensor information are referred to as “non-braking-time vehicle outside-condition information and the like”. In this case, the learning device 200 can perform supervised learning by using the braking-time vehicle outside-condition information and the like as correct answer data and the non-braking-time vehicle outside-condition information and the like as incorrect answer data.

FIG. 5 is a flowchart illustrating a flow of control according to the above-described learning processing. This control is executed by the calculation unit 203 of the learning device 200. In the following description, it is assumed that this control is started when the communication unit 201 of the learning device 200 receives the learning data LD from the vehicle 10 in a state where a learning completion flag FLG to be described later is set to OFF.

In the control illustrated in FIG. 5, in step S51, the calculation unit 203 acquires information transmitted from the vehicle 10 as the learning data LD. The information to be acquired here is the braking-time vehicle outside-condition information, non-braking-time vehicle outside-condition information, or the like.

In step S53, the calculation unit 203 performs machine learning using the learning data LD acquired in step S51.

For example, the calculation unit 203 performs machine learning of the neural network. In this case, the calculation unit 203 may give the configuration of the neural network, the initial value of the connection weight between the neurons, and the initial value of the threshold of each neuron by a template or by an input of an operator. When relearning is performed, the calculation unit 203 may create a neural network based on the learning result LR.

In this case, the calculation unit 203 inputs the learning data LD to the input layer of the neural network and acquires an output value that is a value output from the output layer of the neural network. Then, the calculation unit 203 calculates an error between the acquired output value and the correct value or the incorrect value. Specifically, when the learning data LD is the braking-time vehicle outside-condition information or the like, the calculation unit 203 sets a difference between the output value and 1, which is a correct value, as an error. On the other hand, in a case where the learning data LD is the non-braking-time vehicle outside-condition information or the like, the calculation unit 203 sets a difference between the output value and 0, which is an incorrect value, as an error.

The calculation unit 203 updates the connection weight between the neurons and the threshold of each neuron so as to reduce these errors. At this time, the calculation unit 203 can use a well-known back propagation through time method, a stochastic gradient descent method, or the like.

When the parameters of the neural network are updated in this manner, the calculation unit 203 proceeds to the processing of step S55. In step S55, the calculation unit 203 determines whether the machine learning is completed. For example, the calculation unit 203 determines whether the number of pieces of data DC of the learning data LD used for machine learning is greater than or equal to a determination value DCTh. The determination value DCTh is a threshold of the number of pieces of data DC of the learning data LD for determining whether the machine learning has been sufficiently performed.

When the number of pieces of data DC is greater than or equal to the determination value DCTh, the calculation unit 203 considers that the machine learning is completed (S55: YES), and proceeds to the processing of step S59. On the other hand, in a case where the number of pieces of data DC is less than the determination value DCTh, the calculation unit 203 does not consider that the machine learning is completed (S55: NO), and proceeds to the processing of step S57.

In step S57, the calculation unit 203 sets the learning completion flag FLG to OFF. Thereafter, the calculation unit 203 temporarily ends this control.

In step S59, the calculation unit 203 sets the learning completion flag FLG to ON. Then, the calculation unit 203 stores the parameters of the neural network at that time in the storage unit 202 as the learning result LR. Thereafter, the calculation unit 203 ends this control.

In the present embodiment, the calculation unit 203 executes the learning program LP upon receiving the learning data LD from the vehicle 10, but the present disclosure is not limited thereto. For example, after a predetermined number of pieces of learning data LD are stored in the storage unit 202, machine learning using the learning data LD as an input may be performed. In addition, the preparation of the learning data LD and the machine learning may be separate processing.

The learned model LM is generated through the execution of the above control. Such a learned model LM is provided in the braking control device 100.

### Operations and Effects of Present Embodiment

First, functions and effects of the method for generating the learned model LM will be described.

(1-1) According to the present embodiment, the learning device 200 acquires the learning data LD from the vehicle 10 via the network 300. Therefore, the learning device 200 can easily collect the learning data LD. In particular, by acquiring the braking-time vehicle outside-condition information from the vehicle 10, highly accurate teacher data (correct answer data) can be easily collected.

(1-2) In the present embodiment, since the imaging information is used as the learning data LD, it is possible to perform machine learning in consideration of various peripheral conditions outside the vehicle 10.

(1-3) In the present embodiment, since the map information is used as the learning data LD, it is possible to perform machine learning in consideration of the area where the vehicle 10 is traveling and the road where the vehicle 10 is traveling.

(1-4) In the present embodiment, machine learning is performed using sensor information as the learning data LD in addition to vehicle outside-condition information. Here, even if the vehicle outside-condition information is the same, the probability of the braking operation may change depending on the behavior of the vehicle 10. For example, when the vehicle 10 is traveling on an expressway, the probability of the braking operation is basically low. However, when the vehicle 10 is traveling at a low speed on an expressway, a traffic jam may occur in the area where the vehicle 10 is traveling. Therefore, when the vehicle 10 is traveling at a low speed on an expressway, the probability of the braking operation is high. Therefore, it is possible to generate the highly accurate learned model LM by performing machine learning using the sensor information in addition to the vehicle outside-condition information.

(1-5) According to the present embodiment, by acquiring the learning data LD not from one vehicle 10 but from a plurality of vehicles 10, it is possible to suppress occurrence of deviation in a data group of the learning data LD due to a habit of a specific driver. In the present embodiment, since the learning data LD is acquired from the vehicle 10 via the network 300 as described above, the learning data LD can be easily acquired from a plurality of vehicles 10.

Next, functions and effects of the braking control device 100 will be described.

(1-6) In the present embodiment, the learning apparatus 110 is configured by a learned model LM to which machine learning for estimating the probability of the braking operation corresponding to the vehicle outside-condition is applied. Then, by inputting the vehicle outside-condition information of the traveling vehicle 10 to the learning apparatus 110, the responsivity of the braking operation in the braking device 30 according to the value (indicator IND) output from the learning apparatus 110 is set. Thus, the responsivity of the braking operation according to a wide variety of vehicle outside-condition can be suitably set.

### Second Embodiment

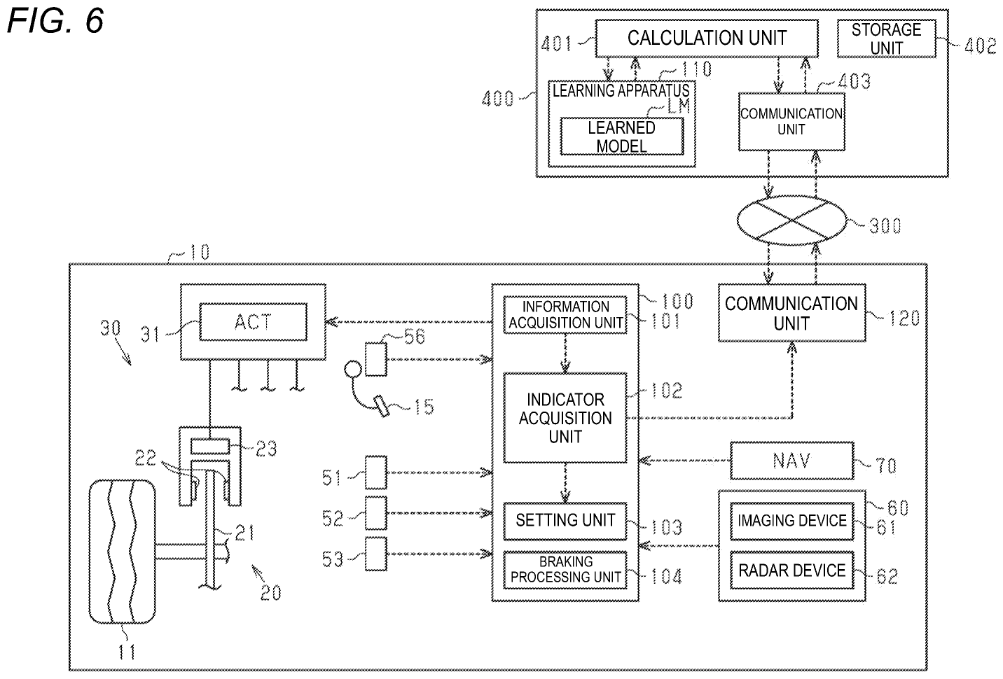

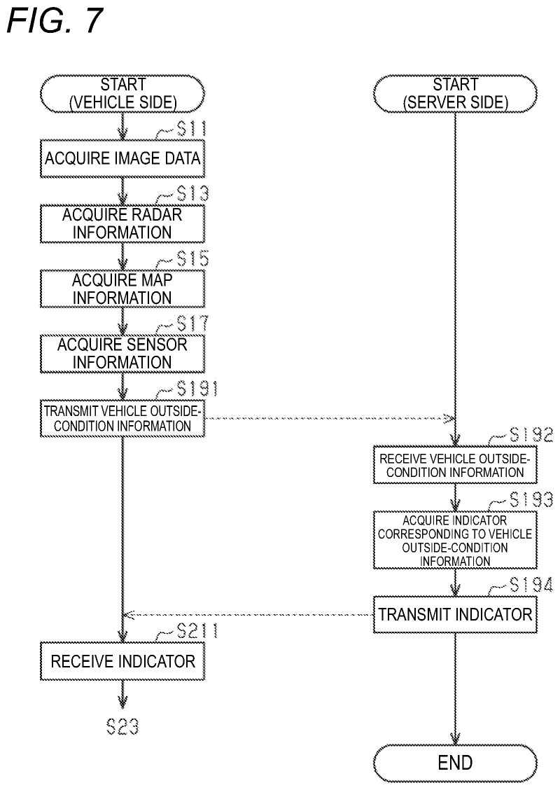

A second embodiment will be described with reference to FIGS. 6 and 7. The second embodiment is different from the first embodiment in that a learning apparatus 110 is provided in an external vehicle server device 400. In the following description, portions different from those of the first embodiment will be mainly described, and the same reference numerals will be given to the same or corresponding member configurations as those of the first embodiment, and redundant description will be omitted.

FIG. 6 illustrates an example of a vehicle control system including the vehicle 10 and the external vehicle server device 400.

### Vehicle

As illustrated in FIG. 6, the vehicle 10 includes a braking device 30, a braking control device 100, and a communication unit 120. The braking control device 100 transmits the vehicle outside-condition information and the like from the communication unit 120 to the external vehicle server device 400 via the network 300.

### External Vehicle Server Device

The external vehicle server device 400 includes a calculation unit 401, a storage unit 402, a learning apparatus 110, and a communication unit 403. In the external vehicle server device 400, the communication unit 403 receives the vehicle outside-condition information and the like transmitted from the vehicle 10 via the network 300. The external vehicle server device 400 inputs the vehicle outside-condition information and the like received by the communication unit 403 to the learning apparatus 110. Then, the external vehicle server device 400 transmits indicator information, which is information related to the indicator IND which is a value output from the learning apparatus 110, from the communication unit 403 to the vehicle 10 via the network 300.

### Control Related to Pre-Braking Processing

FIG. 7 is a sequence diagram illustrating a flow of control related to the pre-braking processing. A control program related to the pre-braking processing on the vehicle 10 side is stored in the storage unit of the braking control device 100 and executed by the calculation unit of the braking control device 100. The control program related to the pre-braking processing on the external vehicle server device 400 side is stored in the storage unit 402 of the external vehicle server device 400 and executed by the calculation unit 401 of the external vehicle server device 400.

In steps S11 to S15, the braking control device 100 of the vehicle 10 acquires vehicle outside-condition information. Specifically, the braking control device 100 functions as the information acquisition unit 101 to acquire the imaging information output by the imaging device 61 as the vehicle outside-condition information (step S11). The braking control device 100 acquires the radar information output by the radar device 62 as vehicle outside-condition information (step S13). The braking control device 100 acquires map information from the navigation device 70 as vehicle outside-condition information (step S15).

In step S17, the braking control device 100 functions as the information acquisition unit 101 to acquire sensor information from the sensor system.

In step S191, the braking control device 100 functions as the indicator acquisition unit 102 to transmit the vehicle outside-condition information and the like from the communication unit 120 to the external vehicle server device 400.

Upon receiving the vehicle outside-condition information and the like transmitted by the vehicle 10 in step S191, the external vehicle server device 400 executes the processing of steps S192 to S194.

In step S192, the calculation unit 401 of the external vehicle server device 400 inputs the vehicle outside-condition information and the like transmitted by the vehicle 10 to the learned model LM of the learning apparatus 110.

In step S193, the calculation unit 401 acquires a value output from the learned model LM of the learning apparatus 110 as the indicator IND.

In step S194, the calculation unit 401 transmits indicator information, which is information related to the indicator IND, from the communication unit 201 to the vehicle 10.

Upon receiving the indicator information transmitted by the external vehicle server device 400 in step S194, the braking control device 100 of the vehicle 10 executes the processing of step S211. In step S211, the braking control device 100 functions as the indicator acquisition unit 102 to acquire the indicator IND indicated by the indicator information. Then, the braking control device 100 proceeds to the processing of step S23. Since the flow of processing after step S23 is similar to that of the first embodiment, the description thereof is omitted.

### Functions and Effects of Present Embodiment

According to the present embodiment, in addition to the effects equivalent to the above (1-1) to (1-5), the following effects can be further obtained.

(2-1) In the present embodiment, the braking control device 100 of the vehicle 10 transmits the vehicle outside-condition information and the like to the external vehicle server device 400. Then, the external vehicle server device 400 inputs the vehicle outside-condition information and the like received from the vehicle 10 to the learned model LM, and transmits indicator information regarding the indicator IND, which is a value output from the learned model LM, to the vehicle 10. As a result, the braking control device 100 of the vehicle 10 sets responsivity of the braking operation according to the indicator IND indicated by the indicator information received from the external vehicle server device 400. Thus, the responsivity of the braking operation according to a wide variety of vehicle outside-condition can be suitably set.

(2-2) In the present embodiment, the learning apparatus 110 is provided in the external vehicle server device 400, and the learning apparatus 110 is not provided in the braking control device 100. As a result, the braking control device 100 can be downsized.

(2-3) The learning apparatus 110 is provided in the external vehicle server device 400. Therefore, by providing a function corresponding to the learning device 200 in the external vehicle server device 400 or connecting the learning device 200 to the external vehicle server device 400, the relearning of the learned model LM can be performed while providing the indicator IND output from the learning apparatus 110 to the vehicle 10.

### Modifications

The plurality of embodiments can be modified as follows. The plurality of embodiments and the following modifications can be implemented in combination with each other within a range not technically contradictory.
In the plurality of embodiments described above, the pre-braking processing is not executed when the indicator IND is less than the indicator determination value INDTh, but the present disclosure is not limited thereto as long as the responsivity of the braking operation according to the indicator IND can be set. For example, a plurality of indicator determination values INDTh having different sizes may be set, and the distance between the brake pad 22 and the rotor 21 may be gradually shortened as the probability of the braking operation increases. For example, the distance between the brake pad 22 and the rotor 21 may be continuously shortened as the probability of the braking operation increases without setting the indicator determination value INDTh.
In the plurality of embodiments described above, the process of reducing the operation amount of the braking device 30 required from the generation of the braking request to the application of the braking force to the wheel 11 has been exemplified as the braking preparation processing, but the present disclosure is not limited thereto. Specifically, the braking preparation processing may be a process of increasing the operation speed of the braking device 30. For example, when the braking device 30 includes an electric pump that supplies brake fluid to the wheel cylinder 23 and an electromagnetic valve provided in a reflux passage connecting an outlet and an inlet of the electric pump, the process of enhancing the responsivity of the braking operation may be a process of increasing the discharge amount of the electric pump in a state where the electromagnetic valve is opened. In this case, by reducing the opening degree of the electromagnetic valve in accordance with the generation of the braking request, a larger amount of brake fluid can be supplied to the wheel cylinder 23 as the discharge amount of the electric pump is larger.
In the plurality of embodiments described above, the vehicle outside-condition information and the sensor information are used for machine learning, but it is not essential to use the sensor information for machine learning. In a case where only the vehicle outside-condition information is used for machine learning, the indicator acquisition unit 102 inputs only the vehicle outside-condition information out of the vehicle outside-condition information and the sensor information to the learning apparatus 110.
In the plurality of embodiments described above, the imaging information, the radar information, and the map information are used for machine learning as the vehicle outside-condition information, but all of these pieces of information may not be used for machine learning.
In the plurality of embodiments described above, the vehicle outside-condition information obtained from the plurality of vehicles 10 is used for machine learning, but the vehicle outside-condition information obtained from one vehicle 10 (for example, the own vehicle) may be used for machine learning.
In the plurality of embodiments described above, the machine learning of the neural network is performed, but the learned model is not limited to the neural network.
The braking control device 100 is not limited to a device that includes a CPU and a ROM and executes software processing. For example, a dedicated hardware circuit that performs hardware processing on at least a part of those subjected to software processing in the plurality of embodiments may be provided. Examples of the dedicated hardware circuit include an ASIC.
In the plurality of embodiments described above, the caliper type friction brake 20 has been exemplified, but the friction brake may be a drum type friction brake. In this case, the friction brake includes a brake lining as a friction material and a brake drum as a material to be rubbed.
In the plurality of embodiments described above, the hydraulic friction brake 20 is exemplified, but the friction brake may be an electric friction brake. In this case, the friction material is driven by an electric motor.

### Technical Idea That can be Grasped From Embodiments and the Like

Next, a technical idea that can be grasped from the plurality of embodiments and modifications will be described.

(A) The learning apparatus is preferably one that has performed machine learning using the vehicle outside-condition information acquired by a plurality of the vehicles as learning data.

(b) The information acquisition unit preferably acquires information of an image obtained by imaging the outside of the vehicle as the vehicle outside-condition information.

(c) The information acquisition unit preferably acquires information detected by a radar device mounted on the vehicle as the vehicle outside-condition information.

(d) The information acquisition unit preferably acquires information regarding a map including a position where the vehicle travels as the vehicle outside-condition information.

(e) The braking mechanism includes a portion to be rubbed that rotates integrally with the wheel, and a friction portion that is displaced in a direction relatively approaching the portion to be rubbed and in a direction relatively separating from the portion to be rubbed, and applies a braking force to the wheel by bringing the friction portion into contact with the portion to be rubbed, and

the setting unit executes a process of causing the friction portion to relatively approach the portion to be rubbed.

(f) The braking mechanism includes a portion to be rubbed that rotates integrally with the wheel, and a friction portion that is displaced in an approaching direction that is a direction of relatively approaching the portion to be rubbed and in a separating direction that is a direction of relatively separating from the portion to be rubbed, and applies a braking force to the wheel by bringing the friction portion into contact with the portion to be rubbed, and

the setting unit executes a process of causing the braking device to generate a driving force in a range in which a state in which the friction portion is stationary can be maintained.

(g) A vehicle system including: a vehicle including a braking device that applies a braking force to wheels of the vehicle; and an external vehicle server device provided outside the vehicle, in which

the vehicle includes:

a vehicle-side communication unit that transmits vehicle outside-condition information to the external vehicle server device, the vehicle outside-condition information being information regarding a condition outside the vehicle; and

a setting unit that sets responsivity of the braking operation according to a probability of occurrence of the braking operation for applying the braking force in the braking device, and

the external vehicle server device includes:

a server-side communication unit that transmits an indicator output from a learning apparatus to the vehicle by inputting the vehicle outside-condition information transmitted from the vehicle communication unit to the learning apparatus that has performed machine learning for estimating a probability of the braking operation based on the vehicle outside-condition information.

(h) A learning method for learning a learned model used for control of a second vehicle based on learning data acquired from a first vehicle, the learning method including:

acquisition processing of acquiring, as teacher data, vehicle outside-condition information regarding a condition outside the first vehicle when a braking operation for applying a braking force to wheels of the first vehicle is generated; and

learning processing of inputting the vehicle outside-condition information acquired in the acquisition processing to the learned model, and performing supervised learning of estimating a probability of occurrence of a braking operation for applying a braking force to a wheel of the second vehicle based on a condition outside the second vehicle by comparing a value output from the learned model with a result that a braking operation has occurred.

In this case, the first vehicle and the second vehicle may be different vehicles or the same vehicle.

1. A braking control device for a vehicle which is applied to a braking device to apply a braking force to a wheel of the vehicle, the braking control device comprising:
an information acquisition unit that acquires vehicle outside-condition information that is information regarding a situation outside the vehicle; and
a setting unit that sets responsivity of a braking operation according to an indicator output from a learning apparatus by inputting the vehicle outside-condition information acquired by the information acquisition unit to the learning apparatus that has performed machine learning for estimating a probability of occurrence of the braking operation for applying a braking force to the wheel based on a situation outside the vehicle in the braking device.

2. The braking control device for the vehicle according to claim 1, wherein the learning apparatus performs machine learning based on the vehicle outside-condition information acquired when the braking operation is performed.

3. The braking control device for the vehicle according to claim 1, wherein the setting unit causes the braking device to prepare for the braking operation when the degree of probability of the braking operation indicated by the indicator is greater than or equal to a determination value.

4. The braking control device for the vehicle according to claim 1, wherein the setting unit causes the braking device to prepare for the braking operation when the degree of probability of the braking operation indicated by the indicator is greater than or equal to a determination value.
